(19) United States
(12) Patent Application Publication
(10) Pub. No.: US 2009/0252533 A1
(43) Pub. Date: Oct. 8, 2009

(54) DOCUMENT MANAGEMENT SYSTEM, IMAGE FORMING APPARATUS AND DOCUMENT MANAGEMENT METHOD

(75) Inventors: Naofumi Yamamoto, Kawasaki-shi (JP); Takahiro Fuchigami, Yokosuka-shi (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/062,023

(22) Filed: Apr. 3, 2008

(51) Int. Cl. G03G 15/22

(52) U.S. Cl. 399/151

(57) ABSTRACT

A document management system of the invention is a document management system in which identification information is embedded and an image is printed, and includes a print management unit to generate information relating to printing and including at least information of distribution destinations of printed materials on which the image is printed, an identification information management unit that issues the identification information the number of which is equal to the number of the printed materials, assigns one piece of the identification information to each of the printed materials, correlates the information of the distribution destinations with the identification information, and manages them, and an image formation unit to print, on a recording sheet, the image in which the identification information associated with the information relating to the printing is embedded.

### BACKGROUND OF THE INVENTION

1. Technical Field of the Invention

The present invention relates to a document management system which can manage a document printed by an image forming apparatus until it is discarded, the image forming apparatus and a document management method.

2. Related Art

Recently, there is increased a necessity of preventing the leakage of, in particular, a secret document among documents printed by an image forming apparatus such as a copier or a printer. Besides, as documents to be processed by an image forming apparatus are increased, a necessity of enhancing the efficiency of retrieval of the documents and reuse thereof is also increased.

Hitherto, in order to prevent the leakage of a document and to improve the efficiency of the retrieval, there is proposed a technique in which an ID number is embedded in the document, and information relating to printing, including the distribution destination of the document, is associated with the ID number and is managed.

For example, an image processing apparatus disclosed in JP-A 2003-298830 is configured such that ID information can be embedded in a printed image by electronic watermark. According to this image processing apparatus, it is also possible to control the permission or prohibition of copying or the like based on the embedded ID information, and it is possible to prevent the leakage from occurring.

Besides, an output document management system disclosed in JP-A 2005-190365 is configured such that ID information is embedded in a document, and when the document is discarded, the ID information is read and can be notified to a server, and therefore, the discard of the document can be grasped, and the document can be managed from the creation thereof to the discard. Accordingly, according to this output document management system, for example, it is possible to manage which document in secret documents is not discarded but remains, and the leakage of the secret can be indirectly suppressed.

According to this kind of technique of the related art, the source of the paper document can be retrieved based on the ID number embedded in the document, and the leakage of the document can be suppressed, and the location of the document or whether the document has been discarded or not, or the like can be grasped.

Besides, in the case where a document image is printed or copied, an ID number embedded in the original (source original) as the source of the printing or copying is managed, so that the history of an operation such as printing or copying, the source of the source original, and the like can be known. In this case, it becomes possible to grasp the flow of the document and to refer to the source original, and the range of use of the document image is widened.

However, in the related art, consideration is not given to the case where plural copies of a document are printed. Thus, in the related art, the plural printed documents can not be differentiated, and in the case where information is leaked, it is impossible to identify which document of the plural printed documents is leaked. Accordingly, in the related art, it can not be said that the suppression effect of leakage prevention is sufficient. Besides, also in the document management system including the discard of the document, it is impossible to identify which document of the issued plural documents is discarded. Thus, in the related art, the management of the individual documents can not be performed satisfactorily.

### SUMMARY OF THE INVENTION

The present invention has been made in view of the above circumstances, and it is an object to provide a document management system, an image forming apparatus, and a document management method, in which even in the case where plural copies of a document are printed, the distribution destination of each print can be specified, and the suppression effect of document leak is high.

In order to achieve the above object, according to an aspect of the invention, in a document management system in which in which an image is printed on a recording sheet and identification information is embedded in the recording sheet, the document management system includes a print management unit configured to generate information relating to printing and including at least information of distribution destinations of printed materials on which the image is printed, an identification information management unit that issues the identification information the number of which is equal to the number of the printed materials, assigns one piece of the identification information to each of the printed materials, correlates the information of the distribution destinations with the identification information and manages them, and an image formation unit configured to print, on a recording sheet, the image in which the identification information associated with the information relating to the printing is embedded.

Besides, in order to achieve the above object, according to another aspect of the invention, an image forming apparatus can electrically communicate with an identification information management unit configured to manage identification information to be embedded and printed in a document, and embeds the identification information received from the identification information management unit and prints an image, and is characterized in that the image forming apparatus includes an image formation unit configured to print an image of the document on a recording sheet, and a print management unit that gives information relating to printing of the image of the document to the identification information management unit, controls the image formation unit, and causes the image of the document to be printed while the identification information received from the identification information management unit is embedded, the number of the identification information issued is equal to the number of prints, one piece thereof is assigned to each of printed materials, the information relating to the printing includes at least information of distribution destinations of the printed materials printed, and the information of the distribution destinations is associated with the identification information and is stored in an identification information storage unit.

Besides, in order to achieve the above object, according to another aspect of the invention, a document management method includes sending information relating to printing of an image of a document, sending an issuance request for identification information to be embedded in printed materials, issuing identification information, the number of which is equal to the number of prints, to be embedded in the printed materials in response to the issuance request and assigning one piece of the identification information to each of the printed materials, receiving the information relating to the printing, correlating the information with the identification information, storing them in an identification information storage unit, and printing the image of the document while the identification information is embedded, wherein the information relating to the printing includes at least information of distribution destinations of the printed materials printed.

### BRIEF DESCRIPTION OF THE DRAWINGS

In the accompanying drawings:

FIG. 1 is a schematic total structural view showing an embodiment of a document management system and an image forming apparatus of the invention;

FIG. 2 is a schematic block diagram showing a structural example of a server;

FIG. 3 is a schematic block diagram showing a structural example of an MFP;

FIG. 4 is a schematic block diagram showing a structural example of a personal computer;

FIG. 5 is a schematic block diagram showing a structural example of a shredder;

FIG. 6 is a flowchart showing a procedure at the time when a process is performed in which in a case where plural copies of a documents are printed, an intrinsic ID number is embedded in each of printed materials and printing is performed, so that a distribution destination can be managed for each of the printed materials;

FIG. 7 is an explanatory view showing an example of the contents of an ID information storage unit in which print information is associated with an ID number and is stored;

FIG. 8 is a flowchart showing a procedure at the time when a process is performed to copy a document in which an ID number is embedded and printed so that the ID number of the source original can be traced from the copy document (copied material);

FIG. 9 is an explanatory view showing an example of the contents of an ID information storage unit in a case where a document in which an ID number is embedded and printed is copied;

FIG. 10 is a flowchart showing a procedure at the time when a process is performed in which, when a document in which an ID number is embedded and printed is discarded, information indicating that this document has been discarded is associated with the ID number and is stored in an ID information storage unit; and

FIG. 11 is a flowchart showing a procedure at the time when a process is performed in which, when a document in which an ID number is embedded and printed is discarded by a shredder, information indicating that this document has been discarded is associated with the ID number and is stored in an ID information storage unit.

### DETAILED DESCRIPTION

Embodiments of a document management system, an image forming apparatus and a document management method of the invention will be described with reference to the accompanying drawings.

### (1) Structure

A multi function peripheral having a copy function, a printer function, a facsimile function, a scanner function and the like can be used as an image forming apparatus. In the following description, there is described an example of a case where the multi function peripheral (MFP) is used as the image forming apparatus.

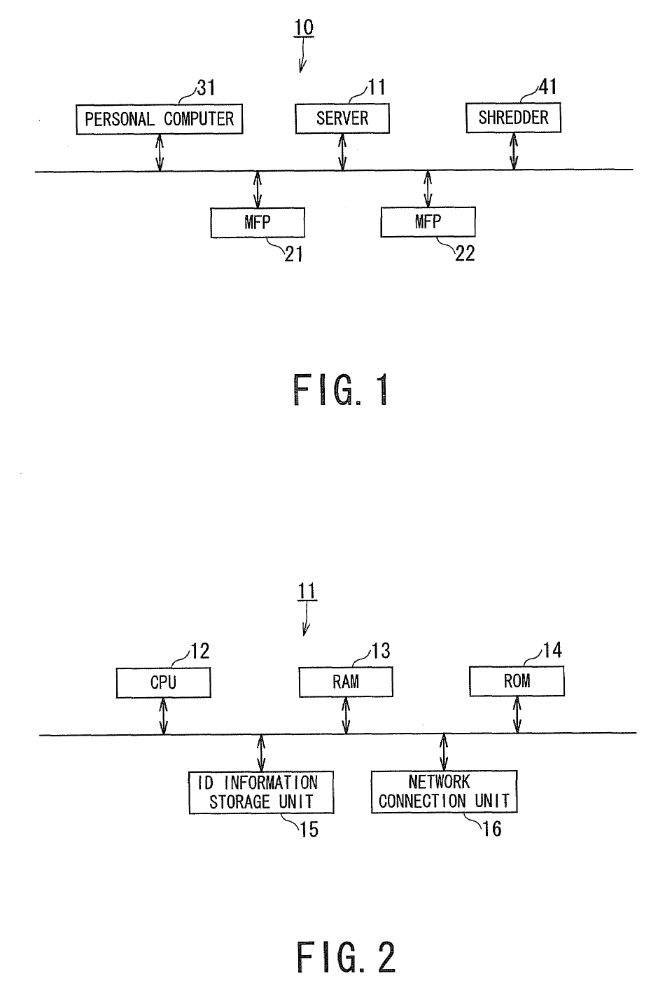

FIG. 1 is a schematic total structural view showing an embodiment of a document management system and an image forming apparatus of the invention.

A document management system 10 includes a server 11, an MFP 21, an MFP 22, a personal computer 31 as an information processing apparatus and a shredder 41, which are connected to be capable of electrically communicating with one another.

The document management system 10 can include plural image forming apparatuses, plural shredders and plural personal computers. FIG. 1 shows an example of a case where the two MFPs as the image forming apparatuses are included.

### (1-1) Structure of the Server 11

First, the structure of the server 11 will be described in brief.

FIG. 2 is a schematic block diagram showing a structural example of the server 11.

As shown in FIG. 2, the server 11 includes a CPU 12, a RAM 13, a ROM 14, an ID information storage unit 15 and a network connection unit 16.

The CPU 12 controls the operation of the server 11 in accordance with a program stored in the ROM 14. The CPU 12 loads a document management program for the server 11 stored in the ROM 14 and data necessary for execution of the program into the RAM 13. The CPU 12 controls the server 11 in accordance with the program for the server 11 and executes various processes such as a process in which in the case where plural copies of a document are printed, an intrinsic ID number (identification information) is embedded in each of printed materials and printing is performed, and a copying process in which the ID embedded in the document is used.

The CPU 12 functions as at least an ID management unit (identification information management unit) by the document management program for the server 11. The ID management unit uses a necessary work area of the RAM 13 as a temporal storage area of data. The ID management unit may be constructed by a hardware logic of a circuit or the like without using the CPU 12.

The ID management unit issues ID numbers (identification information) which are to be embedded in printed material and the number of which is equal to the number of prints, and assigns one of the ID numbers to each of the printed materials. It is assumed that the ID numbers are unique numbers at least in the document management system 10. Of course, the uniqueness of the numbers may be kept in a range including another system.

Besides, the ID management unit controls reading and writing of data with respect to the ID information storage unit 15 (identification information storage unit), for example, information (hereinafter referred to as print information) relating to printing of a document image is associated with the ID number and is stored in the ID information storage unit 15.

The print information includes at least information of a distribution destination of a document, and includes image information of the document, information of the number of prints and information of printing date. Besides, in the case where the document management system 10 includes plural personal computers, information of a personal computer which has issued a print instruction may be included.

The RAM 13 provides a work area to temporarily store a program executed by the CPU 12 and data.

The ROM 14 stores a boot program of the server 11, the document management program for the server 11, and various data necessary for execution of these programs.

The ROM 14 may have a structure including a recording medium readable by the CPU 12, such as a magnetic or optical recording medium or a semiconductor memory, and may be constructed such that part of or all of the programs and data in the ROM 14 are downloaded through an electronic network.

The ID information storage unit 15 associates the information (print information) relating to the printing of the document image with the ID number assigned to the document and stores them.

Various information communication protocols according to forms of networks are implemented in the network connection unit 16. The network connection unit 16 connects the server 11 to the other electrical equipments constituting the document management system 10 in accordance with the various protocols. Electrical connection through the electronic network can be applied to this connection. Here, the electronic network means a general information communication network using an electric communication technique, and includes a telephone communication line network, an optical fiber communication network, a cable communication network, a satellite communication network and the like in addition to a LAN (Local Area Network) and the Internet network.

### (1-2) Structure of the MFP 21

Next, the structure of the MFP 21 will be described in brief. Since the MFP 22 has the same structure and function as those of the MFP 21, the description thereof will be omitted.

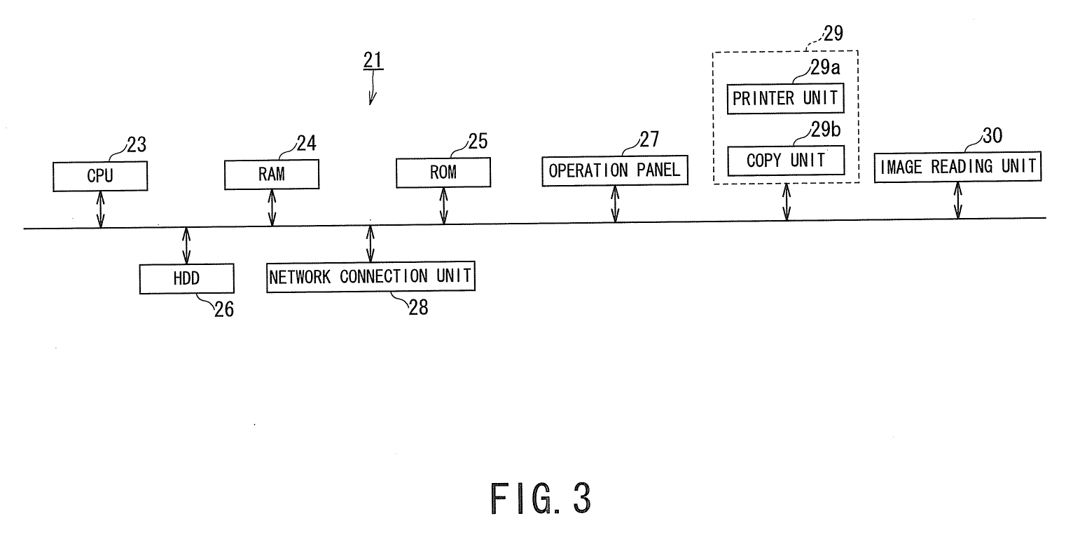

FIG. 3 is a schematic block diagram showing a structural example of the MFP 21.

As shown in FIG. 3, the MFP 21 includes a CPU 23, a RAM 24, a ROM 25, a hard disk drive (HDD) 26, an operation panel 27, a network connection unit 28, an image formation unit 29 and an image reading device 30.

The CPU 23 controls the operation of the MFP 21 in accordance with a program stored in the ROM 25. The CPU 23 loads a document management program for the MFP 21 stored in the ROM 25 and data necessary for execution of the program into the RAM 24. The CPU 23 controls the MFP 21 in accordance with the program for the MFP 21, and executes various processes such as a process in which in the case where plural copies of a document are printed, an intrinsic ID number is embedded in each of printed materials and printing is performed, and a copying process in which the ID embedded in the document is used.

The CPU 23 functions as at least a print management unit, a copy management unit, and a discard management unit by the document management program for the MFP 21. These function realizing units use a necessary work area of the RAM 24 as a temporal storage area of data. These function realizing units may be constructed by a hardware logic of a circuit or the like without using the CPU 23.

The print management unit gives print information to the server 11. Besides, the print management unit controls a printer unit 29a of the image formation unit 29 so that the ID number received from the server 11 is embedded and printed, and information of a distribution destination is merge-printed, and causes the document image to be printed.

When the image of the document is copied by the copy unit 29b of the image formation unit 29, the copy management unit extracts the ID number embedded in the document. Then, the copy management unit gives the extracted ID number and information (hereinafter referred to as copy information) relating to copying to the server 11. Besides, the copy management unit controls the copy unit 29b of the image formation unit 29 so that the ID number received from the server 11 is embedded and printed, and the information of the distribution destination is merge-printed, and causes the document image to be copied.

Further, the copy management unit causes the display unit of the operation panel 27 to display the distribution destination associated with the ID number extracted from the document. Then, when an instruction that this distribution destination is made the distribution destination of a copied material is given by the user through the input unit of the operation panel 27, the copy management unit sets this distribution destination as the distribution destination of the copied material.

The copy information includes at least the information of the distribution destination of the copy (copied material), and includes image information of the copy, information of the number of prints and information of print date.

When the document to be discarded is read by the image reading unit 30 of the MFP 21, the discard management unit of the image forming apparatus extracts the ID number embedded in the document to be discarded and gives it to the server 11.

The RAM 24 provides a work area for temporarily storing a program executed by the CPU 23 and data.

The ROM 25 stores a boot program of the MFP 21, the document management program for the MFP 21, and various data necessary for execution of these programs.

The ROM 25 may have a structure including a recording medium readable by the CPU 23, such as a magnetic or optical recording medium or a semiconductor memory, and may be constructed such that part of or all of the programs and the data in the ROM 25 are downloaded through an electronic network.

The HDD 26 stores at least the image read by the MFP 21.

The operation panel 27 includes hard keys, such as buttons, to give respective intrinsic instruction signals to the CPU 23 when they are depressed by the operator, and a display input unit. The operation unit receives the setting of at least the number of copies and distribution destination information in a copying process using an ID embedded in a document.

The display input unit includes an LCD as a display unit and a touch panel as an input unit provided in the vicinity of the LCD. The LCD is controlled by the CPU 23, and displays information for operating the MFP 21 and plural keys (hereinafter referred to as soft keys) for operating the MFP 21. The touch panel gives information of an instruction position on the touch panel by the user to the CPU 23 of the MFP 21.

Various information communication protocols according to forms of networks are implemented in the network connection unit 28. The network connection unit 28 connects the MFP 21 to the other electrical equipments constituting the document management system 10 in accordance with the various protocols. Electrical connection through the electronic network can be applied to this connection. Here, the electronic network means a general information communication network using an electric communication technique, and includes a telephone communication line network, an optical fiber communication network, a cable communication network, a satellite communication network and the like in addition to a LAN (Local Area Network) and the Internet network.

The image formation unit 29 realizes functions of copy, printer and the like of the MFP 21. On the other hand, the image reading device 30 realizes the scanner function of the MFP 21. FIG. 1 schematically shows an example in which the MFP 21 has the scanner, copy and printer functions, the copy function and the printer function are realized by the printer unit 29a and the copy unit 29b of the image formation unit 29, and the scanner function is realized by the image reading device 30.

### (1-3) Structure of the Personal Computer 31

Next, the structure of the personal computer 31 will be described in brief.

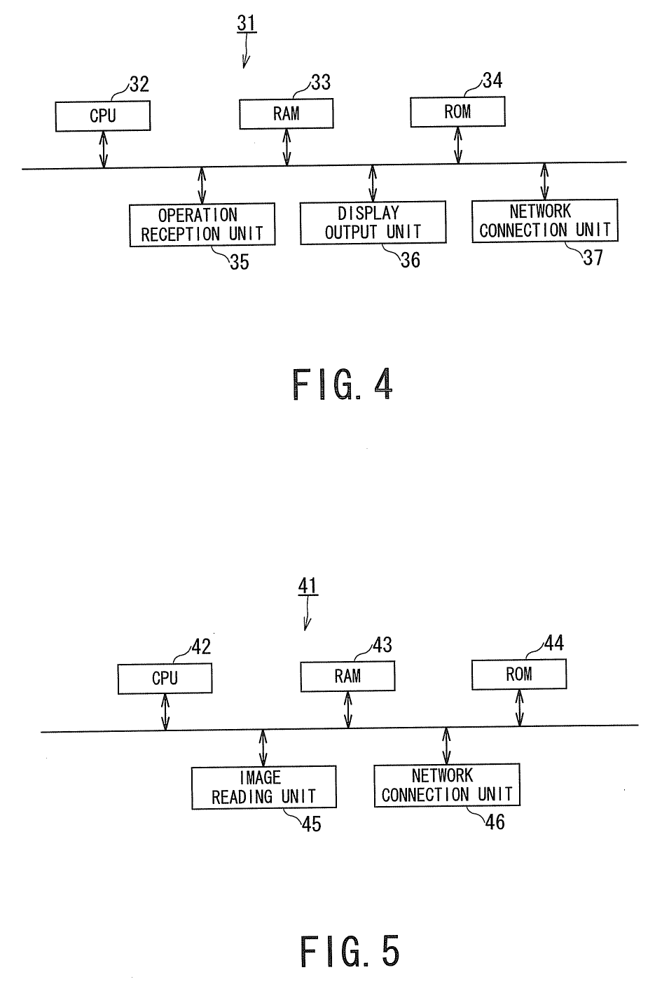

FIG. 4 is a schematic block diagram showing a structural example of the personal computer 31.

As shown in FIG. 4, the personal computer 31 includes a CPU 32, a RAM 33, a ROM 34, an operation reception unit 35, a display output unit 36 and a network connection unit 37.

The CPU 32 controls the operation of the personal computer 31 in accordance with a program stored in the ROM 34. The CPU 32 loads a document management program for the personal computer 31 stored in the ROM 34 and data necessary for execution of the program into the RAM 33. The CPU 32 controls the personal computer 31 in accordance with the program for the personal computer 31, and executes various processes such as a process in which in the case where plural copies of a document are printed, an intrinsic ID number is embedded in each of printed materials and printing is performed.

The RAM 33 provides a work area for temporarily storing the program executed by the CPU 32 and data.

The ROM 34 stores a boot program of the personal computer 31, the document management program for the personal computer 31, and various data necessary for execution of these programs.

The ROM 34 has a structure including a recording medium readable by the CPU 32, such as a magnetic or optical recording medium or a semiconductor memory, and may be constructed such that part of or all of the programs and the data in the ROM 34 are downloaded through an electronic network.

The operation reception unit 35 includes a general input device such as, for example, a keyboard, a touch panel, or a numeric keypad, and outputs an operation input signal corresponding to an operation of a user to the CPU 32.

The display output unit 36 includes a general display output device such as, for example, a liquid crystal display or a CRT display, and displays various information in accordance with the control of the CPU 32.

Various information communication protocols according to forms of networks are implemented in the network connection unit 37. The network connection unit 37 connects the personal computer 31 to the other electrical equipments constituting the document management system 10 in accordance with the various protocols. Electrical connection through the electronic network can be applied to this connection. Here, the electronic network means a general information communication network using an electric communication technique, and includes a telephone communication line network, an optical fiber communication network, a cable communication network, a satellite communication network and the like in addition to a LAN (Local Area Network) and the Internet network.

### (1-4) Structure of the Shredder 41

Next, the structure of the shredder 41 will be described in brief.

FIG. 5 is a schematic block diagram showing a structural example of the shredder 41.

As shown in FIG. 5, the shredder 41 includes a CPU 42, a RAM 32, a ROM 44, an image reading unit 45 and a network connection unit 46.

The CPU 42 controls the operation of the shredder 41 in accordance with a program stored in the ROM 44. The CPU 42 loads a document management program for the shredder 41 stored in the ROM 44 and data necessary for execution of the program into the RAM 43. The CPU 42 controls the shredder 41 in accordance with the program for the shredder 41, and executes various processes such as a process in which, when a document in which an intrinsic ID number is embedded is discarded, information indicating that this document has been discarded is given to the CPU 12 of the server 11.

The CPU 42 functions as at least a discard management unit by the document management program for the shredder 41. The discard management unit uses a necessary work area of the RAM 43 as a temporal storage area of data. The discard management unit may be constructed by a hardware logic of a circuit or the like without using the CPU 42.

When a document to be discarded is read by the image reading unit 45 of the shredder 41, the discard management unit of the shredder 41 extracts the ID number embedded in the document to be discarded and gives it to the server 11.

The RAM 43 provides a work area for temporarily storing the program executed by the CPU 42 and data.

The ROM 44 stores a boot program of the shredder 41, the document management program for the shredder 41, and various data necessary for execution of these programs.

The ROM 44 may have a structure including a recording medium readable by the CPU 42, such as a magnetic or optical recording medium or a semiconductor memory, and may be constructed such that part of or all of the programs and the data in the ROM 44 are downloaded through an electronic network.

When the document to be discarded is inserted in the shredder 41, the image reading unit 45 reads the image of the document.

Various information communication protocols according to forms of networks are implemented in the network connection unit 46. The network connection unit 46 connects the shredder 41 to the other electrical equipments constituting the document management system 10 in accordance with the various protocols. Electrical connection through the electronic network can be applied to this connection. Here, the electronic network means a general information communication network using an electric communication technique, and includes a telephone communication line network, an optical fiber communication network, a cable communication network, a satellite communication network and the like in addition to a LAN (Local Area Network) and the Internet network.

Incidentally, it is sufficient that one server 11 and one ID information storage unit 15 are provided in the document management system 10. Therefore, the installation positions are not limited to the positions shown in FIG. 1 and FIG. 2. For example, the server 11 may be incorporated in the image forming apparatus (for example, the MFP 21). Besides, the ID information storage unit 15 may be incorporated in the image forming apparatus (for example, the MFP 21), in stead of in the server 11.

### (2) Operation

Next, an example of the operation (including the operation of the MFP 21) of the document management system 10 of this embodiment will be described.

### (2-1) Printing

When printing is performed, first, the user inputs information (print information) relating to printing through the operation reception unit 35 of the personal computer 31, and issues an instruction to the computer 31 to cause the MFP 21 to execute printing.

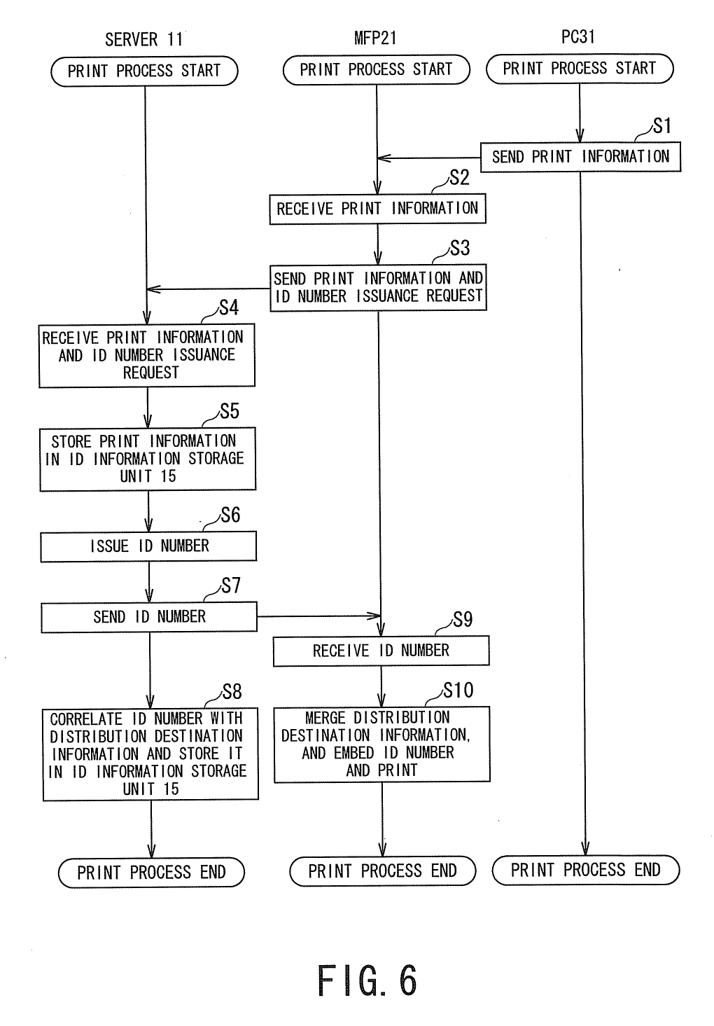

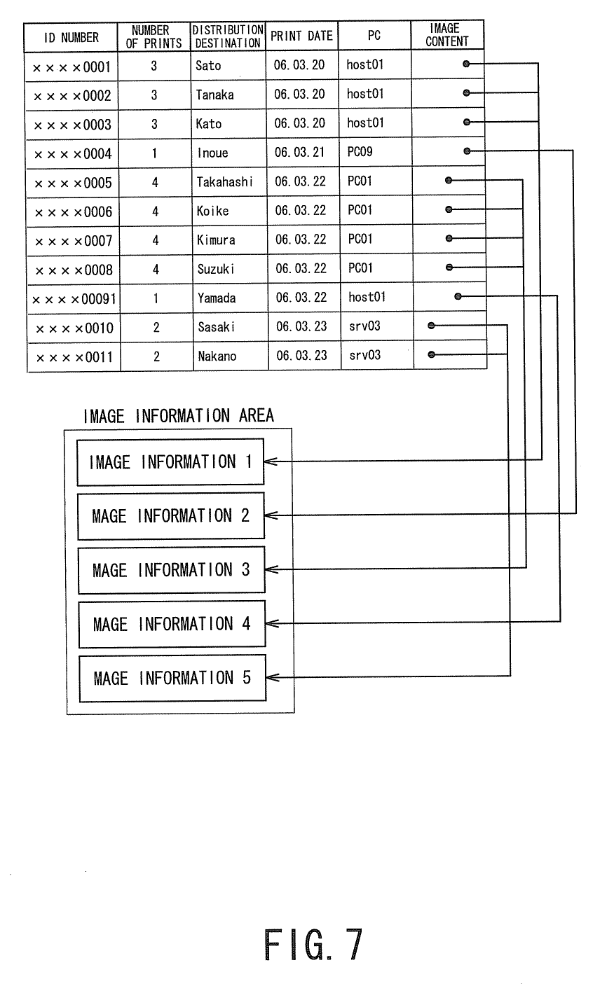

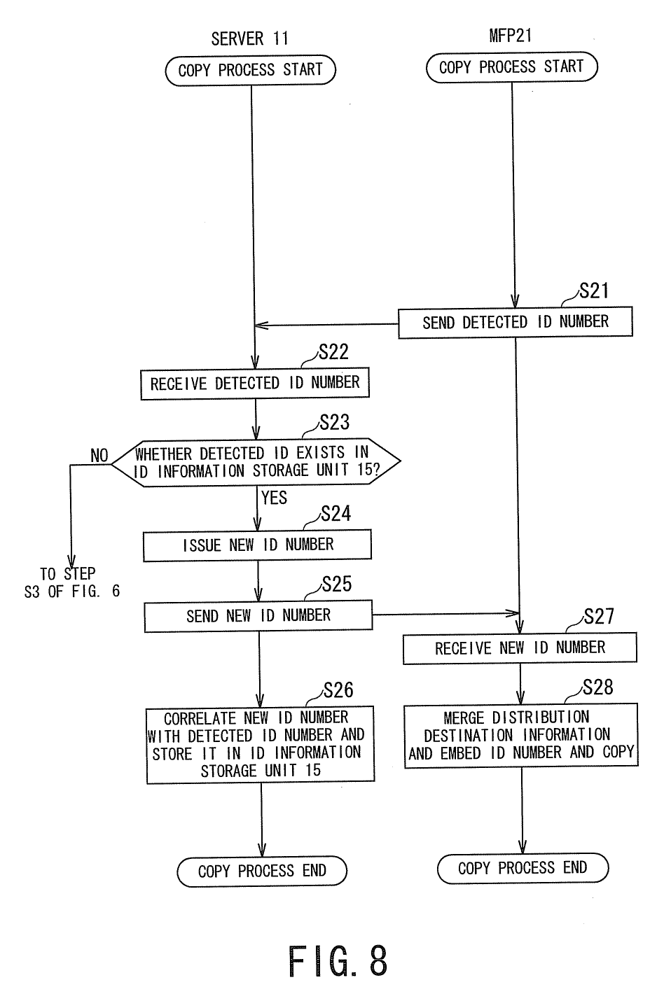

FIG. 6 is a flowchart showing a procedure at the time when a process is performed in which in the case where plural copies of a document are printed, an intrinsic ID number is embedded in each of printed materials and printing is performed, so that a distribution destination can be managed for each of the printed materials. In FIG. 6, a symbol including S and a numeral attached thereto denotes each step in the flowchart.

In the following description, there is described an example of a case where the MFP 21 is used as the image forming apparatus for performing a process such as printing of a document or copying.

At step S1, the CPU 32 of the personal computer 31 sends print information to the MFP 21 and issues an instruction of document printing.

The print information includes information of the number of prints and information of distribution destinations in addition to the image information of the document to be printed. In the following description, an example of a case where the number of prints is more than one will be described.

The print information is instructed by the user through, for example, a user interface of an application or a dialog box of a printer driver.

The distribution destination information is information to identify individuals to whom plural printing results (printed materials) are distributed. As long as the information can identify an individual, it may be a name, or may be a numeral such a serial number.

At step S2, the print management unit of the MFP 21 receives the print information from the personal computer 31.

At step S3, the print management unit of the MFP 21 sends the print information received from the personal computer 31 and an issuance request signal of an ID number to be embedded in the printed material to the server 11.

When sending the print information to the server 11, the print management unit may further add the date of printing, information capable of identifying the personal computer 31 that has issued the print instruction, and the like to the print information.

At step S4, the ID management unit of the server 11 receives the print information and the issuance request signal of the ID number to be embedded in the printed material.

At step S5, the ID management unit of the server 11 causes the print information to be stored in the ID information storage unit 15.

At step S6, the ID management unit of the server 11 issues the ID numbers to be embedded in the printed materials, and the number of the ID numbers is made equal to the number of prints so that one ID number can be assigned to each of the printed materials.

At step S7, the ID management unit of the server 11 sends the ID numbers to be embedded in the printed materials to the MFP 21.

FIG. 7 is an explanatory view showing an example of the contents of the ID information storage unit 15 in which the print information and the ID number are associated with each other and are stored. Incidentally, since the data size of the image information is large, only the image information may be stored in another storage medium (see an image information area of FIG. 7) different from the ID information storage unit 15, and a link to the another storage medium may be provided in the ID information management unit 15, as shown in FIG. 7.

At step S8, the ID management unit of the server 11 associates the issued ID number with the print information stored in the ID information storage unit 15, and causes them to be stored in the ID information storage unit 15. As a result, as shown in FIG. 7, various information such as a distribution destination, the number of prints, a print date, and a document image are associated with each ID number and are stored in the ID information storage unit 15.

At step S9, the print management unit of the MFP 21 receives the ID number to be embedded in the printed material.

At step S10, the print management unit of the MFP 21 controls the printer unit 29a of the image formation unit 29 so that the ID number received from the server 11 is embedded and the information of the distribution destination is merged, and causes the image of the document to be printed.

By the above procedure, in the case where plural copies of a document are printed, an intrinsic ID number is embedded in each of printed materials and printing is performed, so that the distribution destination can be managed for each of the printed materials.

Incidentally, as a technique to embed information in a document and to perform printing, for example, a technique called background pattern printing can be used. In the pattern printing, a specified pattern (background pattern) is recorded in the background region of an image, and a microscopic structure or arrangement of the pattern is changed so that information is embedded in the document. In addition, for example, a technique to minutely change the edge shape of a character or a line drawing can be used.

Besides, in the procedure shown in FIG. 6, the example has been described in which the document image information as information included in the print information is notified from the MFP 21 to the server 11. However, the data size of the document image information is large. In order to reduce the amount of transfer data, for example, the document image information is stored in the HDD 26 of the MFP 21, and the ID number issued by the server 11 is associated with the document image information and may also be stored in the HDD 26.

### (2-2) Copy

When copy (copying) is performed, first, the user inputs information (copy information) relating to the copying through the operation panel 27 of the MFP 21, and instructs the MFP 21 to execute the copy.

Similarly to the print information, the copy information includes information of the number of copies and information of distribution destinations in addition to image information of a document to be copied. In the following description, an example of a case where the number of copies is more than one will be described.

When receiving an instruction to execute copy, the copy management unit of the MFP 21 controls the copy unit 29b of the image formation unit 29 and causes it to read a document to be copied. The copy management unit analyzes the read image and confirms whether an ID number is embedded and printed. In the case where the ID number is embedded, the copy management unit extracts this ID number.

FIG. 8 is a flowchart showing a procedure at the time when a process is performed to copy a document in which the ID number is embedded and printed so that the ID number of the source original can be traced from the copy document. In FIG. 8, a symbol including S and a numeral attached thereto denotes each step in the flowchart.

In the case where a document in which an ID number is not embedded and printed is copied, a procedure equivalent to step S3 to S10 shown in FIG. 6 is executed, so that the ID number is embedded in the copy document. In this case, it is noted that the print management unit at step S3 to S10 of FIG. 6 is replaced by the copy management unit, the print information is replaced by the copy information, and the print of the printer unit 29a is replaced by the copy of the copy unit 29b.

Besides, when the setting of the distribution destination is performed at the time of copying, the ID information storage unit 15 may be used so that the distribution destination associated with the extracted ID number can be easily selected. For example, the ID management unit searches the ID information storage unit 15, the distribution destination associated with the extracted ID number is extracted, and when the copy management unit causes the display unit to display the distribution destination associated with this extracted ID number, the user can give an instruction that this distribution destination is made the distribution destination of the copy document to the MFP 21 through the input unit.

When the ID number embedded in the document to be copied is extracted, the procedure shown in FIG. 8 is started.

At step S21, the copy management unit sends the detected ID number and the copy information to the server 11.

At step S22, the ID management unit of the server 11 receives the detected ID number and the copy information.

At step S23, the ID management unit of the server 11 determines whether the detected ID number is stored in the ID information storage unit 15. In the case where it is stored, advance is made to step S24. On the other hand, in the case where it is not stored, the document is determined to be printed at a place which is not the document management system 10, and a procedure equivalent to step S3 to S10 of FIG. 6 is executed. As a result, an ID number is embedded in the copy document, and the copy document is placed under the control of the document management system 10.

It is noted that the print management unit at step S3 to S10 of FIG. 6 is replaced by the copy management unit, the print information is replaced by the copy information, and the printing of the printer unit 29a is replaced by the copying of the copy unit 29b.

At step S24, the ID management unit of the server 11 issues ID numbers to be embedded in the copy documents, and the number of the ID numbers is made equal to the number of copies so that one ID number can be assigned to each of the copy documents (copied materials).

At step S25, the ID management unit of the server 11 sends the ID number to be embedded in the copy document to the MFP 21.

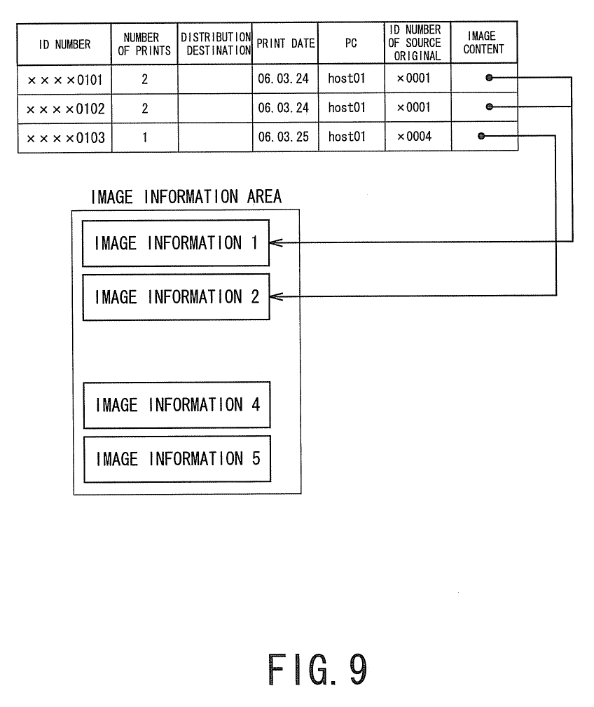

FIG. 9 is an explanatory view showing an example of the contents of the ID information storage unit in the case where the document in which the ID number is embedded and printed is copied.

At step S26, the ID management unit of the server 11 correlates the issued ID number with the ID number of the document stored in the ID information storage unit 15, and causes it to be stored in the ID information storage unit 15. As a result, as shown in FIG. 9, the ID number of the generation copy of the original in which printing or copying has been performed in the document management system 10 is always associated with the ID number of the source original and is stored in the ID information storage unit 15.

Accordingly, by using the information stored in the ID information storage unit 15, the ID number of the source original can be found without fail from the ID number of the generation copy of the original in which printing or copying has been performed in the document management system 10.

At step S27, the copy management unit of the MFP 21 receives the ID number to be embedded in the copy document.

At step S28, the copy management unit of the MFP 21 controls the copy unit 29b of the image formation unit 29 so that the ID number received from the server 11 is embedded and the information of the distribution destination is merged, and causes the image of the original to be copied.

By the above procedure, the original in which the ID number is embedded can be copied so that the ID number of the source original can be traced from the copy document.

### (2-3) Discard (MFP 21)

As a method of managing whether a document has been discarded, there is conceivable a method in which a user causes one of the MFPs constituting the document management system 10 to read the document before the document is discarded, and information indicating that the scanned document is discarded is given to the MFP through the operation panel of the MFP.

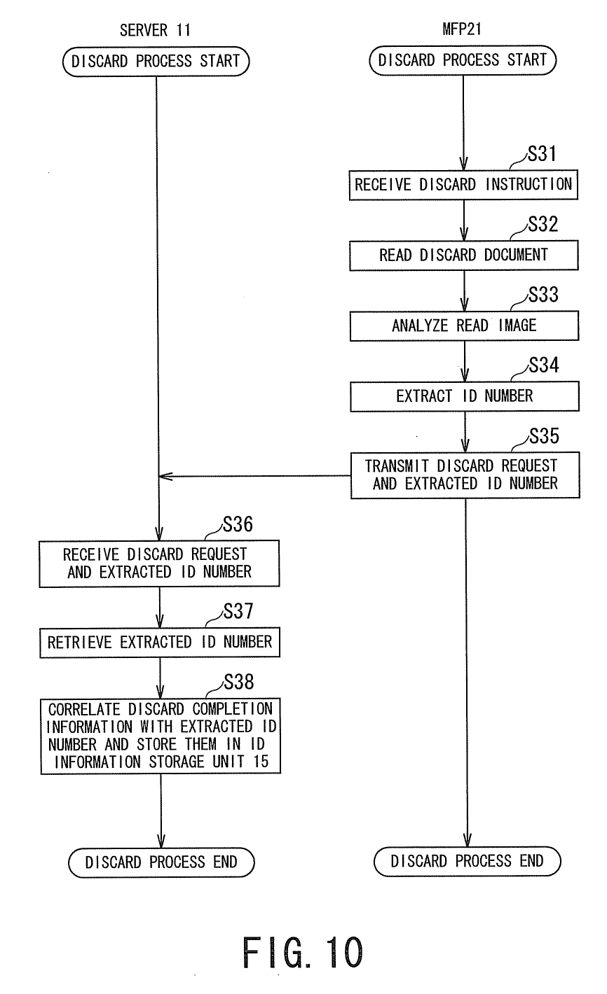

FIG. 10 is a flowchart showing a procedure at the time when a process is performed in which, when a document in which an ID number is embedded and printed is discarded, information indicating that this document will be discarded after reading is associated with the ID number and is stored in the ID information storage unit 15. In FIG. 10, a symbol including S and a numeral attached thereto denotes each step in the flowchart.

This procedure is started at the time point when the document to be discarded is arranged by the user at a position where an image can be read by the MFP 21.

At step S31, the discard management unit of the MFP 21 receives an instruction to discard the document, which has been given to the MFP 21 by the user through the operation panel 27.

At step S32, the discard management unit of the MFP 21 controls the image reading unit 30 to read the image of the document to be discarded.

At step S33, the discard management unit of the MFP 21 analyzes the read image.

At step S34, the discard management unit of the MFP 21 extracts the ID number embedded in the document to be discarded.

At step S35, the discard management unit of the MFP 21 sends a signal (i.e. a discard request signal) which indicates that the document will be discarded after reading and the ID number extracted from the document to be discarded to the server 11.

At step S36, the ID management unit of the server 11 receives the discard request signal and the extracted ID number.

At step S37, the ID management unit of the server 11 searches the ID information storage unit 15 for the received ID number.

At step S38, the ID management unit of the server 11 associates information indicating that discarding has been completed with the ID number embedded in the document to be discarded and causes the ID information storage unit 15 to store them.

By the above procedure, when the document in which the ID number is embedded and printed is discarded, the information indicating that this document has been discarded is associated with the ID number and can be stored in the ID information storage unit 15.

### (2-4) Discard (Shredder 41)

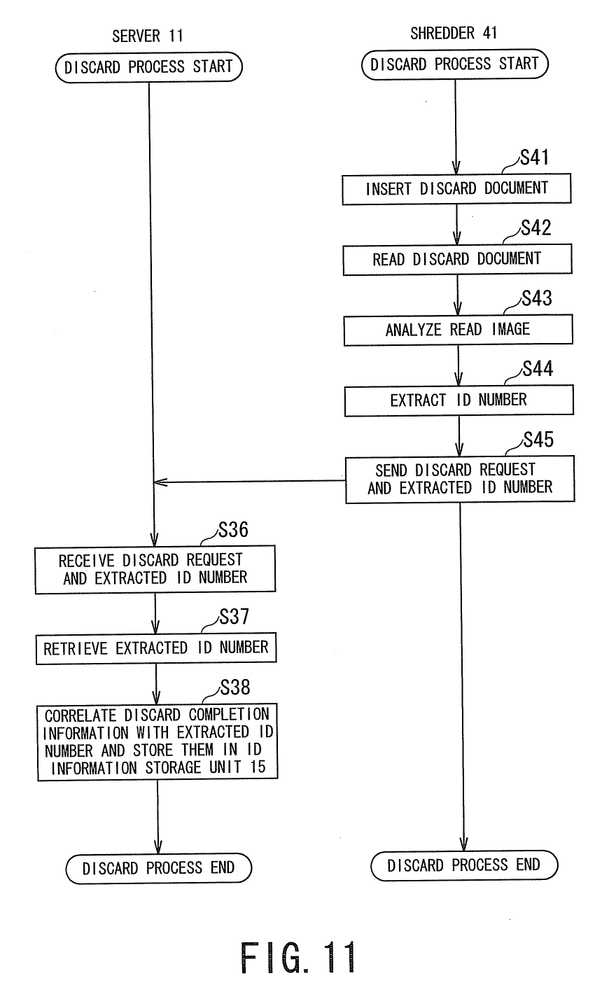

FIG. 11 is a flowchart showing a procedure at the time when a process is performed in which, when a document in which an ID number is embedded and printed is discarded by the shredder 41, information indicating that this document has been discarded is associated with the ID number, and is stored in the ID information storage unit 15. In FIG. 11, a symbol including S and a numeral attached thereto denotes each step in the flowchart. An equivalent step to that of FIG. 10 is denoted by the same symbol and the duplicate description will be omitted.

At step S41, a document to be discarded is inserted in the shredder 41 by the user.

At step S42, the discard management unit of the shredder 41 controls the image reading unit 45 to read the image of the document to be discarded.

At step S43, the discard management unit of the shredder 41 analyzes the read image.

At step S44, the discard management unit of the shredder 41 extracts the ID number embedded in the document to be discarded.

At step S45, the discard management unit of the shredder 41 sends a signal (i.e. a discard request signal) which indicates that the document will be discarded and the ID number extracted from the document to be discarded to the server 11.

Also by the above procedure, when the document in which the ID number is embedded and printed is discarded, the information indicating that this document has been discarded is associated with the ID number and can be stored in the ID information storage unit 15.

### (2-5) Identification of Leak Source

In the case where plural copies are printed in the document management system 10, distribution destinations are merge-printed. Thus, in the case where each of the printed materials is certainly distributed to a person corresponding to the distribution destination, if this document is leaked and the leaked document or its copy can be obtained, the leak source can be easily identified from the obtained document or its copy by the following procedure.

First, the leaked document is read by the document management system 10, and the embedded ID number is detected. Next, the detected ID number is notified to the server 11, and an inquiry is made to the server 11 about the distribution destination in addition to the document content, typographer, and print date. As a result, not only the source of the leaked document, but also the distributed person who should keep and manage the document can be easily traced and identified.

Accordingly, according to the document management system 10 of this embodiment, although the leakage in itself can not be directly prevented, since a leaking person can be identified after the fact, the awareness of leakage prevention is raised, and the document leak can be indirectly suppressed.

In the document management system 10 of this embodiment, even when the number of prints is more than one, the intrinsic ID number is assigned to each of the printed materials. Thus, all documents can be individually differentiated. Accordingly, in the document management system 10 of this embodiment, for each document, it is possible to grasp whether each document has been discarded, and even in the case where plural copies of a document are printed, the distribution destination of each of the printed materials can be identified and the effect of suppressing the document leak is high.

Besides, according to the document management system 10 of this embodiment, in the case where a document is leaked and the leaked document or its copy is obtained, the leak source can be identified very easily. Accordingly, according to the document management system 10 of this embodiment, the document leak can be indirectly suppressed.

Besides, in the document management system 10 of this embodiment, when a document in which an ID number is embedded is copied, the distribution destination of the document image can be retrieved from the ID number. Thus, in the case where a distribution is made to the same distribution destination as the distribution destination of the document image, the setting of the distribution destination can be performed very easily.

The present invention is not limited to the above embodiment as described above, and in an implementation phase, the invention can be embodied while modifying the components within the scope not departing from the gist thereof. Besides, various embodiments of the invention can be made by appropriate combinations of plural components disclosed in the embodiment. For example, some components may be deleted from all the components disclosed in the embodiment.

For example, in this embodiment, although the example has been described in which the ID number is unique only in the document management system 10 (see step S23 of FIG. 8), it may be made unique also in a range exceeding the range of the document management system 10. In this case, when the ID number is registered in the server 11, since the corresponding information always exists in the server 11, it is possible to prevent a different document from being erroneously ID determined.

Besides, in the embodiment, although the example of the process has been described in which the respective steps of the flowchart are performed in time series along the described order, the process may be such that the steps are not necessarily be performed in time series, but are performed in parallel or individually.

What is claimed is:

1. A document management system in which an image is printed on a recording sheet and identification information is embedded in the recording sheet, the document management system comprising:
a print management unit configured to generate information relating to printing, including at least information of distribution destinations of printed materials on which the image is printed;
an identification information management unit that issues the identification information the number of which is equal to the number of the printed materials, assigns one piece of the identification information to each of the printed materials, associates the information of the distribution destinations with the identification information, and manages them; and
an image formation unit configured to print, on the recording sheet, the image in which the identification information associated with the information relating to the printing is embedded.

2. The document management system according to claim 1, wherein the print management unit controls the image formation unit and causes the image to be printed, while the identification information received from the identification information management unit is embedded and the information of the distribution destination is merged.

3. The document management system according to claim 1, wherein the information relating to the printing further includes information of the image to be printed and information of the number of prints.

4. The document management system according to claim 1, further comprising an information processing apparatus that can electrically mutually communicate with the image formation unit, and gives information of the image to be printed, the number of prints, and the information of the distribution destinations to the image formation unit.

5. The document management system according to claim 1, further comprising an identification information storage unit in which the information of the distribution destination and the identification information are associated with each other and stored by the identification information management unit, wherein the image formation unit includes a copy management unit configured to extract the identification information embedded in the image when the image is copied and to give the extracted identification information and information relating to the copying to the identification information management unit, the information relating to the copying includes at least information of distribution destinations of the copied materials copied,
the identification information management unit issues the identification information to be embedded in the copied materials, the number of the identification information is equal to the number of copies and one piece of the identification information is assigned to each of the copied materials, and when the identification information extracted from the image exists in the identification information storage unit, the identification information to be embedded in the copied material is associated with the identification information extracted from the image and is stored in the identification information storage unit, and
the copy management unit controls the image formation unit and causes the image to be copied, while the identification information received from the identification information management unit and to be embedded in the copied material is embedded.

6. The document management system according to claim 5, wherein the image formation unit further includes
an input unit configured to receive an input from a user, and
a display unit configured to display various images, wherein
the identification information management unit searches the identification information storage unit and extracts the distribution destination associated with the identification information extracted from the document, and
the copy management unit causes the display unit to display the distribution destination associated with the identification information extracted from the document, and when an instruction indicating that this distribution destination is made the distribution destination of the copied material is given by the user through the input unit, this distribution destination is set as the distribution destination of the copied material.

7. The document management system according to claim 1, wherein the image formation unit further includes
an image reading unit configured to read an image of the document to be discarded, and
a discard management unit that extracts, when the image of the document is read by the image reading unit, identification information embedded in the document to be discarded, and gives the extracted identification information to the identification information management unit, wherein
when the identification information embedded in the document to be discarded exists in the identification information storage unit, the identification information management unit correlates information indicating that discarding has been completed with the identification information embedded in the document to be discarded, and stores them in the identification information storage unit.

8. The document management system according to claim 1, further comprising a shredder that can mutually electrically communicate with the identification information management unit and the image formation unit, wherein
the shredder includes a discard management unit that extracts, when the document to be discarded is inserted, identification information embedded in the document to be discarded, and gives the extracted identification information to the identification information management unit, and
when the identification information embedded in the document to be discarded exists in the identification information storage unit, the identification information management unit correlates information indicating that discarding has been completed with the identification information embedded in the document to be discarded, and stores them in the identification information storage unit.

9. The document management system according to claim 1, wherein the server includes the identification information storage unit.

10. An image forming apparatus which can electrically communicate with an identification information management unit to manage identification information to be embedded and printed in a document, and embeds the identification information received from the identification information management unit and prints an image, the image forming apparatus comprising:
an image formation unit configured to print an image of the document on a recording sheet; and
a print management unit that gives information relating to printing of the image of the document to the identification information management unit, controls the image formation unit, and causes the image of the document to be printed while the identification information received from the identification information management unit is embedded, wherein
the number of the identification information issued is equal to the number of prints, and one piece thereof is assigned to each of printed materials,
the information relating to the printing includes at least information of distribution destinations of the printed materials printed, and
the information of the distribution destinations is associated with the identification information and is stored in an identification information storage unit.

11. The image forming apparatus according to claim 10, wherein when the image of the document is printed, the print management unit further controls the image formation unit to embed the identification information received from the identification information management unit and to merge the information of the distribution destination.

12. The image forming apparatus according to claim 10, wherein the information relating to the printing further includes image information of the document to be printed and information of the number of prints.

13. The image forming apparatus according to claim 10, wherein image information of the document to be printed, the number of prints, and the information of the distribution destinations are received from an information processing apparatus that can electrically mutually communicate with the image forming apparatus.

14. The image forming apparatus according to claim 10, further comprising a copy management unit that extracts identification information embedded in the document when the image of the document is copied by the image formation unit, and gives the extracted identification information and information relating to the copying to the identification information management unit, wherein
the information relating to the copying includes at least information of distribution destinations of the printed materials printed,
when the identification information extracted from the document exists in the identification information storage unit, the identification information extracted from the document is associated with identification information to be embedded in the copied material and is stored in the identification information storage unit, and
the copy management unit further controls the image formation unit and causes the image of the document to be copied, while the number of issued identification information is equal to the number of copies, one piece thereof is assigned to each of the copied materials, and the identification information which is to be embedded in the copied material and is received from the identification information management unit is embedded.

15. The image forming apparatus according to claim 14, further comprising
an operation reception unit configured to receive an input from a user, and
a display output unit configured to display various images, wherein
the copy management unit causes the display unit to display the distribution destination associated with the identification information extracted from the document, and when an instruction indicating that this distribution destination is made the distribution destination of the copied material is given by the user through the operation reception unit, the copy management unit sets this distribution destination as the distribution destination of the copied material.

16. The image forming apparatus according to claim 10, further comprising
an image reading unit configured to read an image of the document to be discarded, and
a discard management unit that extracts, when the image of the document is read by the image reading unit, identification information embedded in the document to be discarded, and gives the extracted identification information to the identification information management unit, wherein
when the identification information embedded in the document to be discarded exists in the identification information storage unit, information indicating that discarding has been completed is associated with the identification information embedded in the document to be discarded, and is stored in the identification information storage unit.

17. The image forming apparatus according to claim 10, further comprising a shredder that can mutually electrically communicate with the identification information management unit and the image formation apparatus, wherein
the shredder includes a discard management unit that extracts, when the document to be discarded is inserted, identification information embedded in the document to be discarded, and gives the extracted identification information to the identification information management unit, and
when the identification information embedded in the document to be discarded exists in the identification information storage unit, information indicating that discarding has been completed is associated with the identification information embedded in the document to be discarded, and is stored in the identification information storage unit.

18. The image forming apparatus according to claim 10, further comprising the identification information storage unit.

19. A document management method, comprising:
sending information relating to printing of an image of a document;
sending an issuance request for identification information to be embedded in printed materials;
issuing identification information, the number of which is equal to the number of prints, to be embedded in the printed materials in response to the issuance request and assigning one piece of the identification information to each of the printed materials;
receiving the information relating to the printing, correlating the information with the identification information, storing them in an identification information storage unit; and
printing the image of the document while the identification information is embedded,
wherein the information relating to the printing includes at least information of distribution destinations of the printed materials printed.

20. The document management method according to claim 19, wherein
when the image of the document is copied, the identification information embedded in the document is extracted, the extracted identification information and the information relating to copying are sent,
the extracted identification information is received, the identification information, the number of which is equal to the number of copies, to be embedded in the copied materials is issued, one piece of the identification information is assigned to each of the copied materials,
when the identification information extracted from the document exists in the identification information storage unit, the identification information to be embedded in the copied material is associated with the identification information extracted from the document and is store in the identification information storage unit, and
the image of the document is copied while the identification information to be embedded in the copied material is embedded.
